(19) United States
(12) Patent Application Publication
(10) Pub. No.: US 2008/0169993 A1
(43) Pub. Date: Jul. 17, 2008

(54) Antenna

(75) Inventors: Yoshihiko Matsuzawa, Tokyo (JP); Ryuichi Iwata, Tokyo (JP); Hitoshi Tanno, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/898,581

(22) Filed: Sep. 13, 2007

(30) Foreign Application Priority Data
Sep. 15, 2006 (JP) 2006-251164

(51) Int. Cl. H01Q 21/12; H01Q 1/50

(52) U.S. Cl. 343/814

(57) ABSTRACT

An antenna device includes: a plurality of element arrays; a mast member which holds the plurality of element arrays such that the element arrays are arranged in a direction perpendicular to a reference plane; and a first feeding circuit which feeds the element arrays, wherein each element array comprises: a predetermined number of dipole antennas; and a second feeding circuit which feeds the predetermined number of dipole antennas such that the predetermined number of dipole antennas can transmit and/or receive predetermined circularly polarized wave components alone, for each of the element arrays, the first feeding circuit and the second feeding circuit of the element array are connected through an independent transmission path, and each element array is fed with a predetermined phase difference.

This application is based upon and claims the benefit of priority from Japanese patent application No. 2006-251164, filed on Sep. 15, 2006, the disclosure of which is incorporated herein in its entirety by reference.

### BACKGROUND OF THE INVENTION

1. Field of the Invention

The present invention relates to an antenna device for use in reception of, for example, a GPS (Global Positioning System) signal and the like.

2. Description of the Related Art

With widespread utilization of GPS, the utilization of GPS is also being investigated for precise aircraft landing guidance. For the aircraft landing guidance, a positioning accuracy of approximately several centimeters, for example, is required for the aircraft. However, such a positioning accuracy cannot be achieved in a point positioning using only a GPS receiver equipped in the aircraft, and cannot be achieved unless a DGPS (differential GPS) approach is used. In DGPS, a GPS signal is received at a base station installed at a known point on the ground to find an error in GPS positioning to calculate a correction amount, and the correction amount is transmitted, for example, to an airplane. The airplane corrects a value resulting from GPS positioning at the airplane in accordance with the received correction amount, thereby achieving a positioning accuracy of several centimeters, by way of example.

In such DGPS, direct wave components of GPS signals alone must be precisely received at the base station. For receiving GPS signals from GPS satellites in the sky, multipath components can also be received due to reflections from the ground and natural features (for example, buildings and the like) around an antenna. When an antenna is installed at a high altitude away from the ground in order to receive radiowave signals from more GPS satellites, the antenna is more susceptible to multipath due to reflections from the ground. In this regard, multipath components reflected by a vertical wall surface of a building located at a position higher than an antenna hardly constitutes an impeding component to direct waves because a circular polarization direction is inverted.

Accordingly, an antenna for a base station is required to provide vertical-plane sharp cut-off characteristics, i.e., the antenna does not receive incoming waves from a hemispheric direction below a reference plane, which may be, for example, a horizontal plane, and exhibits a directivity only to a hemispheric direction above the reference plane. Further, the antenna for a base station is required to exhibit a uniform directivity within the horizontal plane, i.e., has an equal directivity to any of 360° directions within the reference plane in the upward direction from the reference plane. Since radiowaves from GPS satellites are right-handed circularly polarized waves, the antenna for a base station must be an antenna for receiving right-handed circularly polarized wave components alone. Here, the reference plane refers to a virtual plane for defining the directivity of the antenna. Accordingly, the antenna is not required to comprise a ground conductor, a radiator and the like corresponding to the reference plane.

As a DGPS antenna for a base station which satisfies such conditions, U.S. Pat. No. 5,534,882 issued to Lopez discloses an antenna device which employs element arrays comprising four-element dipole antenna arrays, which are stacked at seven stages with respect to a direction perpendicular to a reference plane direction. Each element array is attached to an antenna mast which is disposed to be perpendicular to the reference plane. In the following, the antenna device described in U.S. Pat. No. 5,534,882 will be described.

In each element array, four dipole antennas are disposed within a plane parallel with the reference plane to surround the position of the antenna mast such that respective directivity axes orient in the 0°-direction, 90°-direction, 180°-direction, and 270°-direction about the position of the antenna mast. In this event, dipole antennas belonging to different element arrays are arranged at positions which match each other with respect to the reference plane, i.e., such that projected positions match with respect to the reference plane. Such arrangement is called “to be in alignment.” For four dipole antennas within the same element array, an antenna feeding system is configured such that phase differences are 0°, 90°, 180°, 270° in order. Stated another way, for four dipole antennas disposed at points which divide the circumference into four equal parts, the feeding system is configured such that the phase advances in the in-plane direction of 360° along the circumference angle. Also, a direction in which a pair of antenna elements of each dipole antenna extends inclines, for example, at approximately 45° with respect to the aforementioned reference plane, thus forming a four-direction slant dipole antenna. In this way, each element array can receive signals from GPS satellites which are right-hand circularly polarized waves.

In this antenna device, each element array is disposed at a predetermined position on the antenna mast, and is fed with a predetermined phase difference and signal level ratio in order to realize directive characteristics, particularly, vertical-plane sharp cut-off characteristics so as not to have directivity to the hemispheric direction below the reference plane.

In the antenna device described in U.S. Pat. No. 5,534,882, the feeding system for powering each element antenna comprises four transmission lines of micro-strip line type. Each transmission line is connected to one of four dipole antennas of each element array to feed the one dipole antenna. As mentioned above, the phase differences are set between the element arrays, and the phase differences are also set between the dipole antennas within an element array, so that the transmission line comprises a delay circuit portion for adjusting the phase difference, and a micro-strip transformer for adjusting the level ratio such that the transmission line can feed each dipole antenna connected thereto with an appropriate phase difference and signal level ratio. Then, a four-port power divider is disposed at powering points as the antenna device, and four distribution ports of the four-port divider are connected to the aforementioned transmission lines, respectively.

However, since the antenna device described in U.S. Pat. No. 5,534,882 employs micro-strip lines as feeding lines for feeding the respective dipole antennas, required characteristics are hard to achieve due to electromagnetic interference of the microstrip lines with the dipole antennas, and interference among four transmission lines. A so-called T-junction must be used for a branch circuit from the transmission line to the dipole antenna without any other option, so that if each dipole antenna is affected by surroundings to vary VSWR (voltage steady wave ratio), the fed phase and amplitude are also affected to vary, resulting in higher vulnerability to disturbance in a radiation pattern. In the structure employed therein, a wiring board formed with the transmission lines of micro-strip line type is twisted about the center axis of the antennas, i.e., the center axis oriented to the direction in which the element arrays are stacked, in order to eliminate the circumferential asymmetry, but a variety of steps are required for forming such a structure. Also, this is not a so realistic structure for an antenna device which is generally installed outdoors.

### SUMMARY OF THE INVENTION

It is therefore an object of the present invention to provide an antenna device which is suitable for use in a base station in DGPS, facilitates the manufacturing and adjustment, and has uniform directivity in the horizontal plane and vertical-plane sharp cut-off characteristics.

According to an exemplary aspect of the present invention, an antenna device includes: a plurality of element arrays; a mast member for holding the plurality of element arrays such that the element arrays are arranged in a direction perpendicular to a reference plane; and a first feeding circuit which feeds the element arrays, wherein each element array comprises: a predetermined number of dipole antennas; and a second feeding circuit which feeds the predetermined number of dipole antennas such that the predetermined number of dipole antennas can transmit and/or receive predetermined circularly polarized wave components alone, for each of the element arrays, the first feeding circuit and the second feeding circuit of the element array are connected through an independent transmission path, and each element array is fed with a predetermined phase difference.

In the present invention, a plurality of element arrays can be fed independently of other element arrays by the first feeding circuit and the transmission path for each element array, and each dipole antenna of each element array can be fed with a predetermined phase difference by the second feeding circuit for each element array, thus making it possible to facilitate, for example, settings and adjustment of the phase differences as well as to facilitate the designing and manufacturing of the transmission paths for feeding. Accordingly, the present invention can provide an antenna device which exhibits, for example, horizontal-plane uniform directivity and satisfactory vertical plane sharp cut-off characteristics, and facilitates the manufacturing and adjustment.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a diagram illustrating the configuration of an antenna device according to one exemplary embodiment;

FIGS. 2A to 2C are diagrams for describing a phase difference of dipole antennas in each element array;

FIGS. 3A and 3B are a plan view and a front view, respectively, illustrating an element array;

FIG. 4 is a diagram illustrating the element array viewed in the direction of arrow A in FIG. 3A;

FIG. 5 is a circuit diagram illustrating the general configuration of the antenna device illustrated in FIG. 1;

FIG. 6 is a circuit diagram illustrating an antenna feeding circuit provided in the element array;

FIG. 7 is a diagram illustrating the configuration of an antenna device according to another exemplary embodiment;

FIG. 8 is a graph showing the orientation directivity characteristic of the antenna device illustrated in FIG. 7; and

FIGS. 9A to 9D are graphs showing vertical-plane amplitude patterns in each of orientations of the antenna device illustrated in FIG. 7.

### DETAILED DESCRIPTION OF THE EXEMPLARY EMBODIMENTS

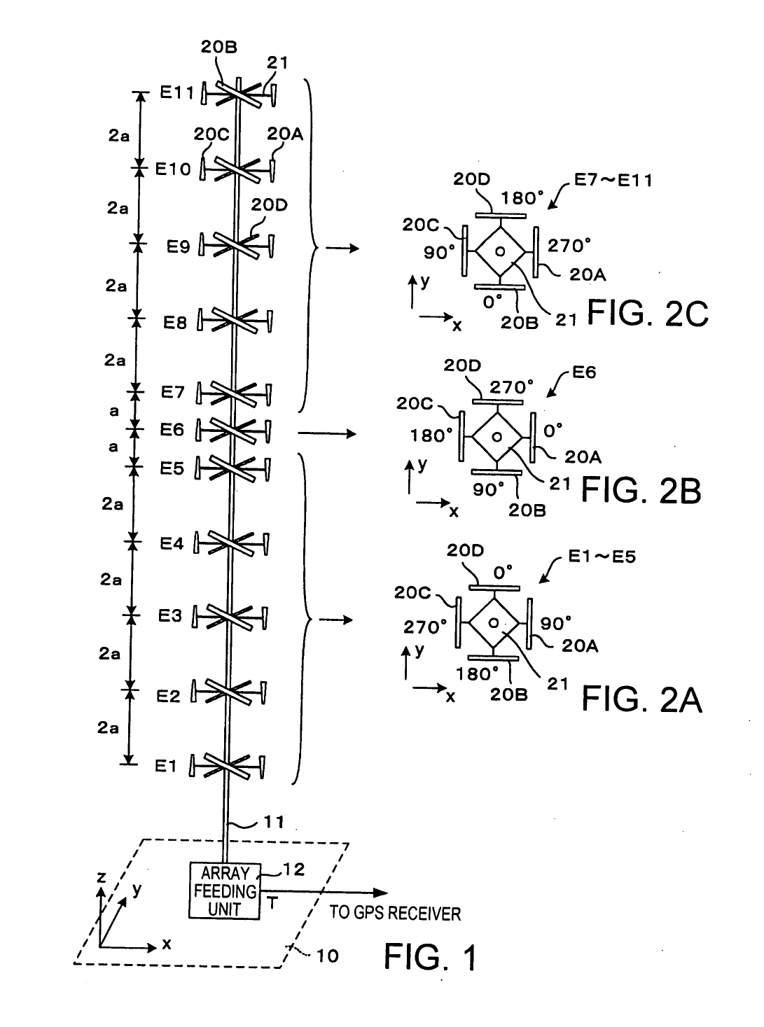

An antenna device according to one exemplary embodiment of the present invention illustrated in FIG. 1 is an antenna device for use in reception of, for example, a GPS signal and the like, and is particularly suitable for a base station when a positioning is performed in accordance with the DGPS (differential GPS) approach, and exhibits horizontal-plane uniform directivity and vertical-plane sharp cut-off characteristics. This antenna device is configured to receive, for example, signals at L1 frequency (center frequency: 1575.42 MHz) from GPS satellites.

For purposes of the following description, three-dimensional xyz coordinates are defined such that reference plane 10 which is a plane for providing for the directivity of the antenna is defined as indicted by broken lines in FIG. 1, the x-axis and y-axis orient in the reference plane, and the z-axis orients to be perpendicular to reference plane 10. While reference plane 10 per se does not correspond to a particular ground conductor or radiator in the antenna device, the horizontal plane is generally employed as reference plane when this antenna device is employed as a base station antenna for the DGPS.

Antenna mast 11 is provided so as to extend perpendicularly to reference plane 10, i.e., extend in the z-axis direction, and eleven element arrays E1 to E11 are attached to antenna mast 11. Each element array includes four dipole antennas 20A to 20D integrated with antenna feeding circuit 21 for feeding or powering these dipole antennas 20A to 20D. Here, element arrays E1 to E11 are attached from the proximal end of antenna mast 11 in this order along the z-axis, arranged in this order. Specifically, antenna mast 11 holds element arrays E1 to E11 such that they are arranged in a direction perpendicular to reference plane 10. Here, element array E1 to element array E5 are attached to antenna mast 11 at intervals of 2a in the z-axis direction, the spacing between element arrays E5, E6 and the spacing between element array E6, E7 are a, and element arrays E7 to E11 are attached to antenna mast 11 at interval of 2a in the z-axis direction. When L1 frequency of GPS is assumed, a is 85 mm by way of example.

In each element array, four dipole antennas 20A to 20D are centrally fed. Antenna feeding circuit 21 is configured as a unit of substantially square shape configured such that antenna mast 11 extends therethrough at the center, as described later, and dipole antennas 20A to 20D are attached to respective apexes of the square. Dipole antennas 20A to 20D have directive axes which exist within a plane parallel with reference plane 10 and orient in directions different from one another by 90°. Dipole antennas 20A of the respective element arrays are at positions which match each other with respect to reference plane 10. Likewise, dipole antennas 20B to 20D of the respective element arrays are at positions which match each other with respect to reference plane 10. In other words, four dipole antennas 20A to 20D can be regarded as seeing in any of four directions within the horizontal plane, respectively. Thus, considering in the aforementioned xyz coordinate system, a dipole antenna positioned in the (+)-direction of the x-axis, viewed from the position of antenna mast 11, is designated as dipole antenna 20A, and in a similar manner, dipole antennas positioned in the (−)-direction of the y-axis, (−)-direction of the x-axis, and (+)-direction of the y-axis are designated as dipole antennas 20B, 20C, 20D, respectively.

Dipole antennas 20A to 20D belonging to the same element array are fed by antenna feeding circuit 21 to generate phase differences shifted 90° by 90° such that they can receive predetermined circularly polarized wave components alone, specifically, they can receive right-hand circularly polarized wave components alone. Also, in order to realize the vertical-plane sharp cut-off characteristics, the feeding is performed such that phase differences are provided even between element arrays E1 to E11. Specifically, with reference to element array E6 positioned at the center, element arrays E1 to E5 placed on the proximal side of antenna mast 11 are powered with a phase difference of +90°, while element arrays E7 to E11 placed on the distal side are powered with a phase difference of −90°. As such, assuming that the phase to dipole antenna 20A of element array E6 positioned at the center is defined as a reference, i.e., its phase difference is 0°, dipole antennas 20A to 20D in element arrays E1 to E5 are fed with phase differences shown in FIG. 2A. Also, each dipole antenna in element array E6 is fed with a phase difference shown in FIG. 2B, and dipole antennas 20A to 20D in element arrays E7 to E11 are fed with phase difference shown in FIG. 2C.

In the antenna device of this exemplary embodiment, dipole antennas 20A to 20D of each element array each incline at approximately 25° with respect to the reference plane, and configured as slant dipole antennas in four directions. In FIG. 1, for indicating whether a dipole antenna is in front of antenna mast 11 or far beyond the position of antenna mast 11, the dipole antenna is shown using bold lines when it is in front of antenna mast 11. In the illustrated ones, the direction in which the dipole antenna element extends inclines at approximately 25° with respect to the reference plane in the clockwise direction, when viewed from the outside of the element array.

In the antenna device described in U.S. Pat. No. 5,534,882, each dipole antenna extends in a direction which inclines with respect to the reference plane. However, in the one described in U.S. Pat. No. 5,534,882, the inclination is 45°, which is different from approximately 25° in this exemplary embodiment. According to investigations of the inventors, when dipole antennas are inclined at 45° as in U.S. Pat. No. 5,534,882, a favorable axial ratio can be provided in the horizontal direction, on the assumption that the reference plane is the horizontal plane, but the axial ratio degrades in the zenith direction, and a reduction in reception level is recognized. This can be thought to be attributable to the influence of the antenna mast and transmission lines for feeding. On the other hand, when the inclination is set on the order of 20° to 30° as in this exemplary embodiment, particularly when set at approximately 25°, the axial ratio in the zenith direction is satisfactory though the axial ratio in the horizontal direction slightly degrades.

At the base of antenna mast 11, array feeding unit 12 is provided, as an array feeding circuit, for feeding element arrays E1 to E11, and array feeding unit 12 has feeding end T connected to a GPS receiver. As will be later described, element arrays E1 to E11 are connected to array feeding unit 12 respectively through coaxial cables dedicated to the respective element arrays. As the coaxial cables, semi-rigid cables are preferably used. As a result, in each element array, only right-handed circularly polarized wave components of GPS signals received by dipole antennas 20A to 20D are combined by antenna feeding circuit 21 of that element array and sent to array feeding unit 12. Array feeding unit 12 combines the GPS signals from respective element arrays E1 to E11 at a predetermined level ratio, and supplies the resulting signal to the GPS receiver.

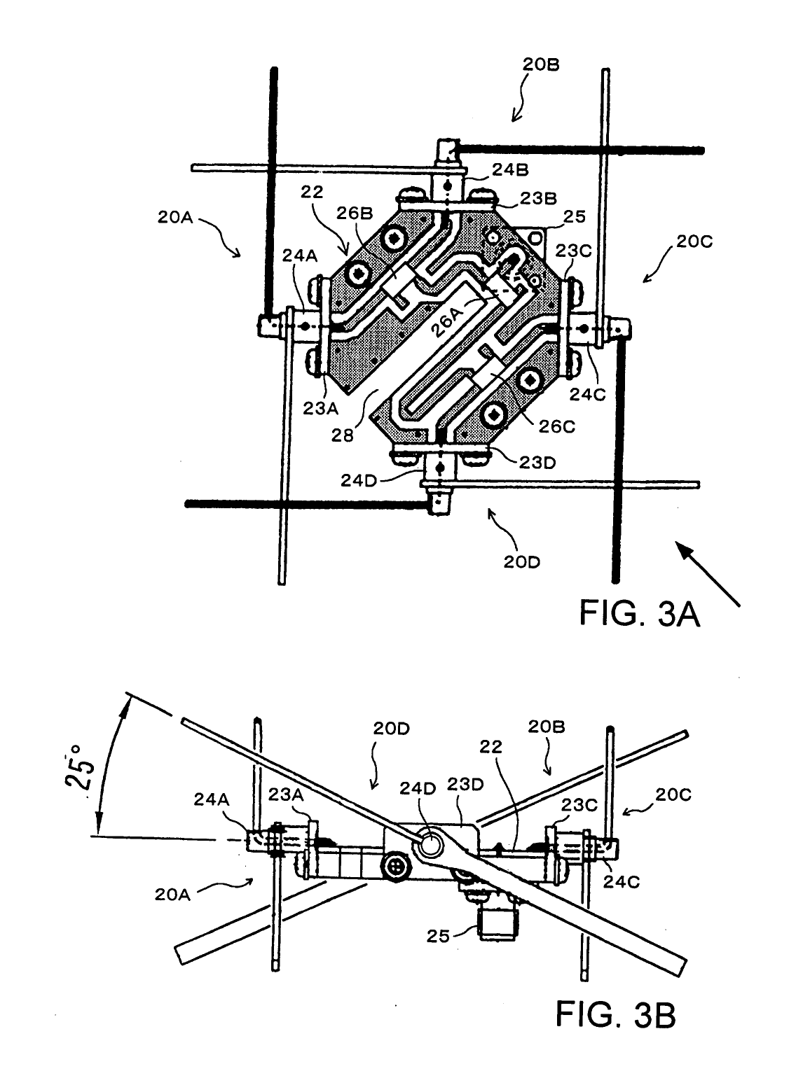

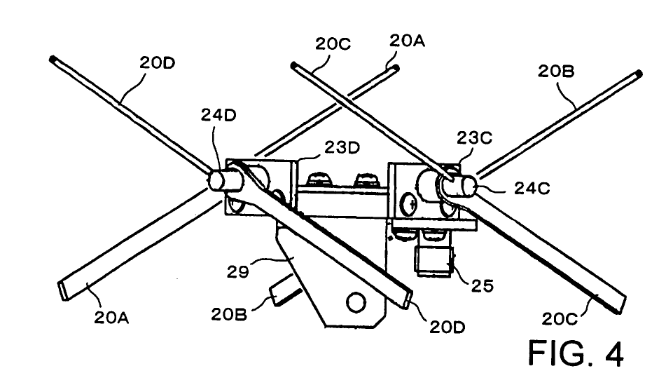

In the following, the configuration of element arrays E1 to E11 will be described in detail. Since element arrays E1 to E11 each have the same configuration, element array E1 is herein given as an example for the description. FIG. 3A is a diagram of element array E1 viewed from above, i.e., in the positive direction of the z-axis, FIG. 3B is a front view of element array E1, and FIG. 4 is a diagram viewed in the direction of the arrow in FIG. 3A.

Element array E1 comprises substantially square circuit board 22 which forms part of antenna feeding circuit 21, as illustrated in FIG. 3A. Circuit board 22 is formed with cutout 28 for receiving antenna mast 11, and coaxial connectors 23A to 23D are provided at four apexes of circuit board 22 for connecting dipole antennas 20A to 20D, respectively. Dipole antennas 20A to 20D are also provided with coaxial connectors 24A to 24D corresponding to coaxial connectors 23A to 23D on circuit board 22. By fitting these coaxial connectors 24A to 24D into coaxial connectors 23A to 23D, dipole antennas 20A to 20D are connected to circuit board 22. As will be later described, antenna feeding circuit 21 and coaxial connectors on circuit board 22 are unbalanced circuit components, and the dipole antennas are antennas which should be powered in a balanced manner, so that it is considered that a balun (balance-unbalance converter circuit) must be essentially inserted, but in this exemplary embodiment, no balun is provided in response to requirements for a reduction in size of the antenna device itself, a reduction in insertion loss due to the balun, and the like. Of course, a balun can be inserted as required. A central conductor of the coaxial connector is directly connected to one of two antenna conductors of the dipole antenna, while an outer conductor of the coaxial connector is directly connected to the other antenna conductor. Even when the dipole antenna is directly connected to the coaxial connector without providing a balun, no large degradation is recognized in the antenna characteristics due to such connection.

On the surface of circuit board 22, a divider circuit is formed by micro-strip lines as antenna feeding circuit 21. On the back of circuit board 22, coaxial connector 25 is provided to be used for electric connection with array feeding unit 12, and a ground conductor is formed on the back of circuit board 22 except for a position at which the central conductor of coaxial connector 25 is drawn out. Coaxial connector 25 serves as a feeding point in antenna feeding circuit 21. A portion filled with dots in FIG. 3A indicates a position at which a conductor pattern is formed on the front surface of circuit board 22. While an equivalent circuit of antenna feeding circuit 21 will be described later, antenna feeding circuit 21 comprises three 90° (quadrature) hybrid couplers 26A to 26C for feeding dipole antennas 20A to 20D from coaxial connector 25 with phase differences as mentioned above. These 90° hybrid couplers 26A to 26C are mounted on the front surface of circuit board 22.

Such circuit board 22 receives antenna mast 11 or an antenna mast into cutout 28 such that antenna mast 11 is sandwiched, and circuit board 22 is attached to antenna mast 11 with attachment bracket 29, not shown in FIGS. 3A and 3B, and is thereby fixed to antenna mast 11.

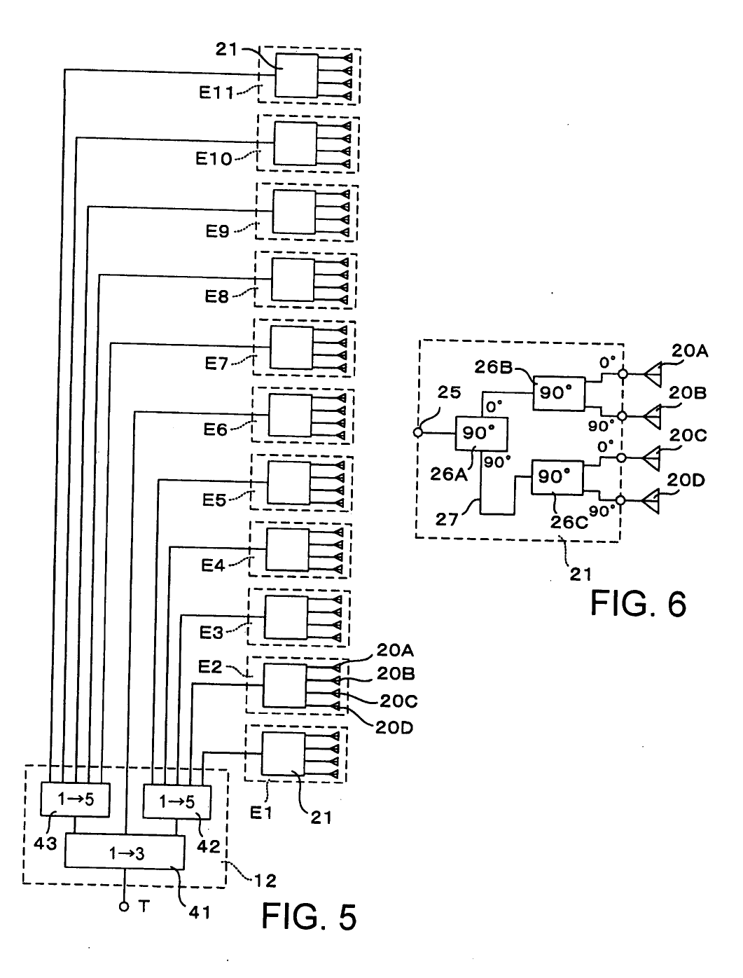

Next, the circuit configuration of this antenna device will be described. FIG. 5 illustrates the circuit configuration of the overall antenna device.

For feeding eleven element arrays E1 to E11 from array feeding unit 12, array feeding unit 12 comprises three-port divider 41 and two five-port dividers 42, 43. In FIG. 5, the three-port divider is indicated as “1→3” and the five-port divider is indicated as “1→5.” An input terminal of three-port divider 41 is connected to feeding end T of array feeding unit 12. One of three outputs of three-port divider 41 is connected to element array E6 which is just at the middle of element arrays E1 to E11. The remaining two outputs of three-port divider 41 are connected to inputs of five-port dividers 42, 43, respectively. Five outputs of five-port divider 42 are connected to element arrays E1 to E5, respectively, and five outputs of five-port divider 43 are connected to element arrays E7 to E11, respectively. By adjusting a distribution ratio to each output terminal in each divider 41 to 43, the aforementioned level ratio to each element array can be set to a predetermined value. For each divider 41 to 43, a so-called Wilkinson type divider or combiner is preferably employed. In this regard, the configuration of divider 41 to 43 which form part of array feeding unit 12 is not limited to the one described above. In other words, array feeding unit 12 can be modified in the number of constituent dividers, connection relationship, and the number of output ports possessed by each divider.

While coaxial cables (for example, semi-rigid cables) are employed for connecting array feeding unit 12 to element arrays E1 to E11, each element array is fed with a phase difference as mentioned above in this exemplary embodiment by adjusting the length of the coaxial cable which connects each element array to array feeding unit 12.

As described above, each element array comprises dipole antennas 20A to 20D and antenna feeding circuit 21. Now, the configuration of antenna feeding circuit 21 will be described with reference to FIG. 6.

Antenna feeding circuit 21 is fed from antenna feeding unit 12 through coaxial connector 25 (see FIGS. 3A and 3B) attached to circuit board 22. An input terminal of first 90° hybrid coupler 26A is connected to coaxial connector 25. A 0° output terminal of this 90° hybrid coupler 26A is connected to an input terminal of second 90° hybrid coupler 26B. A 0° output terminal and 90° output terminal of second 90° hybrid coupler 26B are connected to dipole antennas 20A, 20B, respectively. On the other hand, a 90° output terminal of first 90° hybrid coupler 26A is connected to an input terminal of third 90° hybrid coupler 26C through delay line portion 27 which gives a phase delay of 90°. A 0° output terminal and a 90° output terminal of third 90° hybrid coupler 26C are connected to dipole antennas 20C, 20D, respectively. Here, delay line portion 27 is provided on circuit board 22 as a micro-strip line which has a length that causes a phase delay of 90°.

By thus configuring antenna feeding circuit 21, dipole antennas 20A to 20D connected to this antenna feeding circuit are fed with phase differences of 90° to one another, as described above. As a result, among incoming waves which are received by dipole antennas 20A to 20D, right-handed circularly polarized wave components alone are combined to appear as a received signal at the output of antenna feeding circuit 21, i.e., coaxial connector 25. Then, the received signals from respective element arrays E1 to E11 are combined in array feeding unit 12, and supplied from feeding end T of array feeding unit 12 to the GPS receiver.

Next, antenna device of another exemplary embodiment will be described.

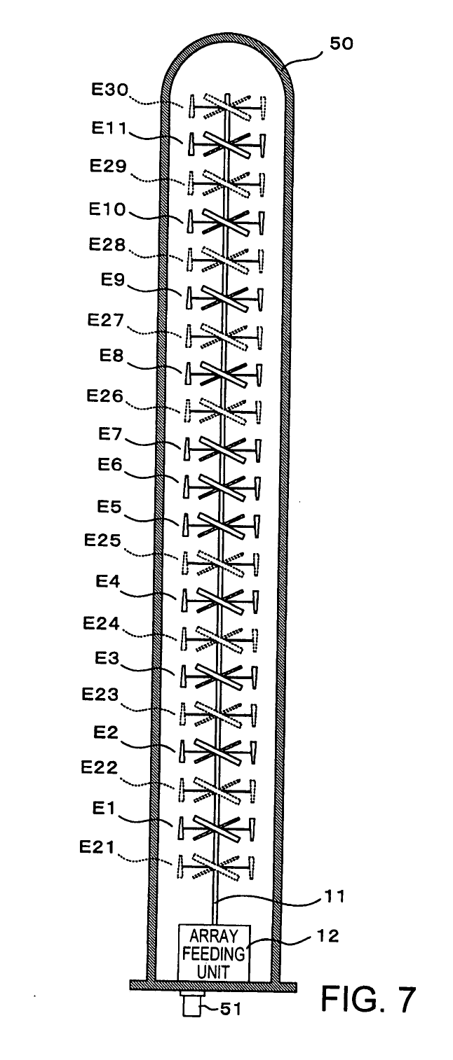

An antenna device illustrated in FIG. 7 further comprises ten parasitic element arrays E21 to E30 added to the antenna device illustrated in FIG. 1. In the antenna device illustrated in FIG. 1, eight intervals between the element arrays are 2a, whereas parasitic element arrays E22 to E29 are disposed in the respective intervals of 2a between the element arrays. In this event, the spacings between a parasitic element and adjacent element arrays on both sides are set at a, respectively. Specifically, parasitic element array E22 is disposed at the position of the midpoint between element arrays E1 and E2; parasitic element array E23 is disposed at the position of the midpoint between element arrays E2 and E3, and subsequently, in a similar manner, parasitic element array E29 is disposed at the position of the midpoint between element arrays E10 and E11. Further, parasitic element array E21 is disposed at a position closer to array feeding unit 12 by distance a than element array E1, while parasitic element array E30 is disposed closer to the leading end of antenna mast 11 by distance a than element array E11. As a result, the element arrays are equally spaced at intervals of a in antenna mast 11 if element arrays E1 to E11 fed from array feeding unit 12 are not distinguished from the parasitic element arrays.

Parasitic element arrays E21 to E30 are similar in configuration to element arrays E1 to E11 in that each has four dipole antennas, but differ in that they do not comprise an antenna feeding circuit and is not fed from array feeding unit 12. Therefore, parasitic element arrays are configured as arrays of passive antenna elements. Parasitic element arrays E21 to E30 are attached to antenna mast 11 such that dipole antennas of parasitic element arrays E21 to E30 are in alignment with element arrays E1 to E11. Feeding points for dipole antennas 20A to 20D in parasitic element arrays E21 to E31 may be terminated by resistors instead of being connected to the antenna feeding circuit, or may be open ends.

Further, the antenna device illustrated in FIG. 7 is covered with radome 50 made, for example, of FRP (fiber reinforced plastic), and is provided with coaxial connector 51 as feeding end T of array feeding unit 12. Of course, the radome may be provided in the antenna device illustrated in FIG. 1.

Next, a description will be given of an example of the antenna device illustrated in FIG. 7 which was actually fabricated, and the characteristics of which were measured. The antenna frequency was matched with L1 frequency from GPS satellites, interval a was set at 85 mm, the inclination of the dipole antennas to the reference plane was set at 25°. In each element array, each dipole antenna had an antenna length of 94 mm. The antenna length called herein refers to the sum of the lengths of two antenna conductors. The spacing between dipole antennas 20A, 20C which opposed across circuit board 22 was equal to the spacing between dipole antennas 20B, 20D which also opposed in the same manner, and was set at 52 mm. Further, the level ratio for each element array E1 to E11 was set as shown in Table 1.

TABLE 1

| | Element Array | | | | | | | | | | |
|---|---|---|---|---|---|---|---|---|---|---|---|
| | E1 | E2 | E3 | E4 | E5 | E6 | E7 | E8 | E9 | E10 | E11 |
| Amplitude Ratio (dB) | −26 | −24 | −19 | −14 | −4 | 0 | −4 | −14 | −19 | −24 | −26 |

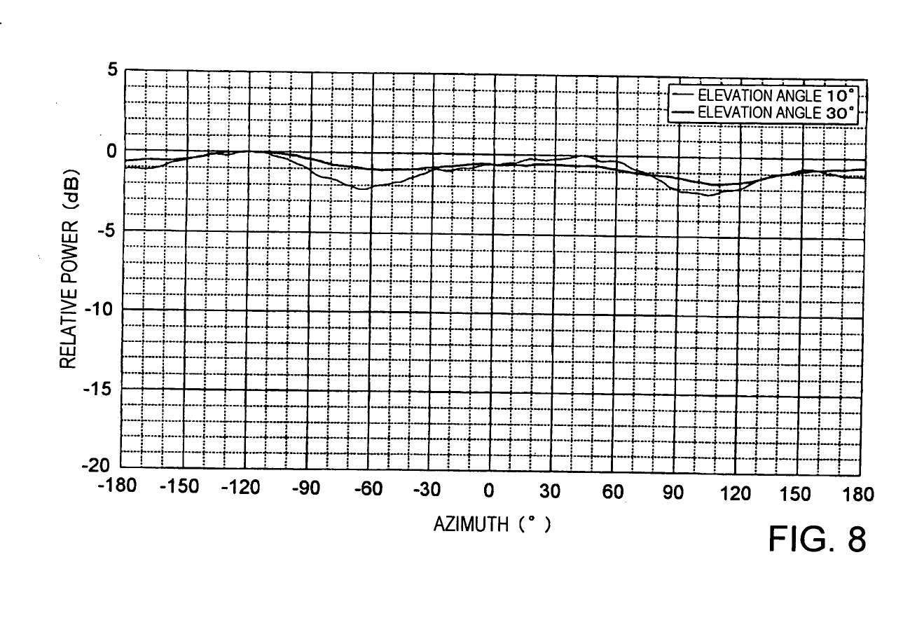

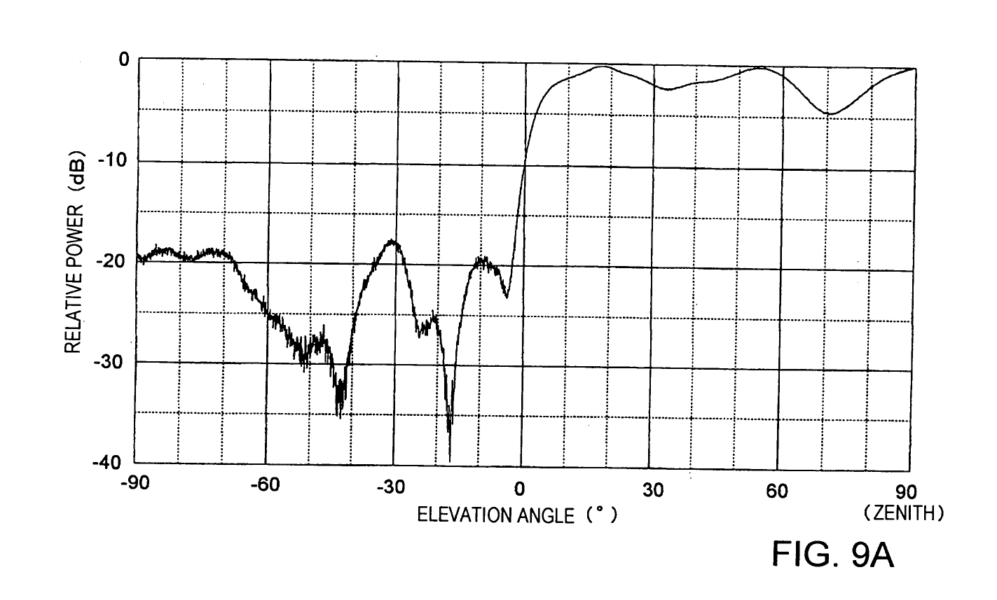

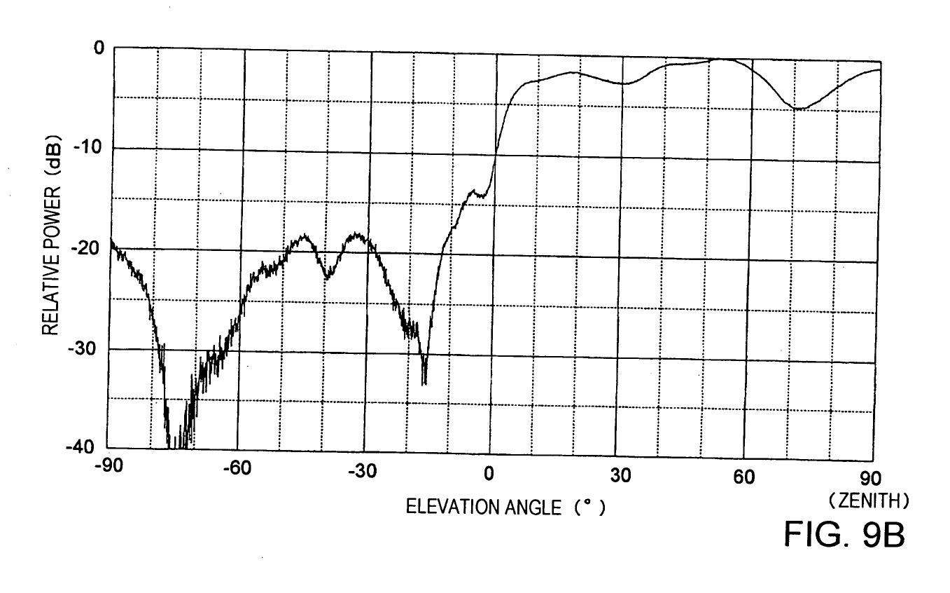

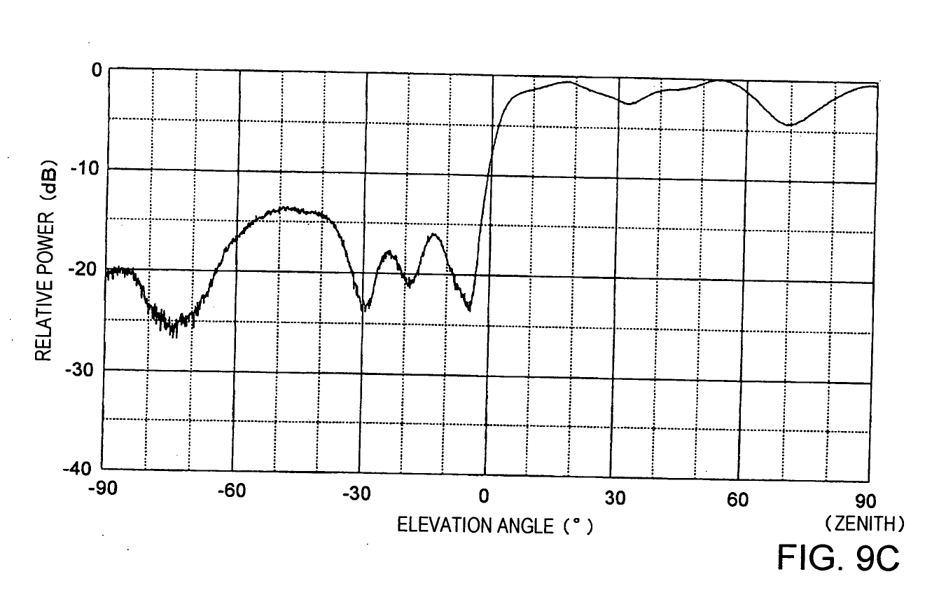

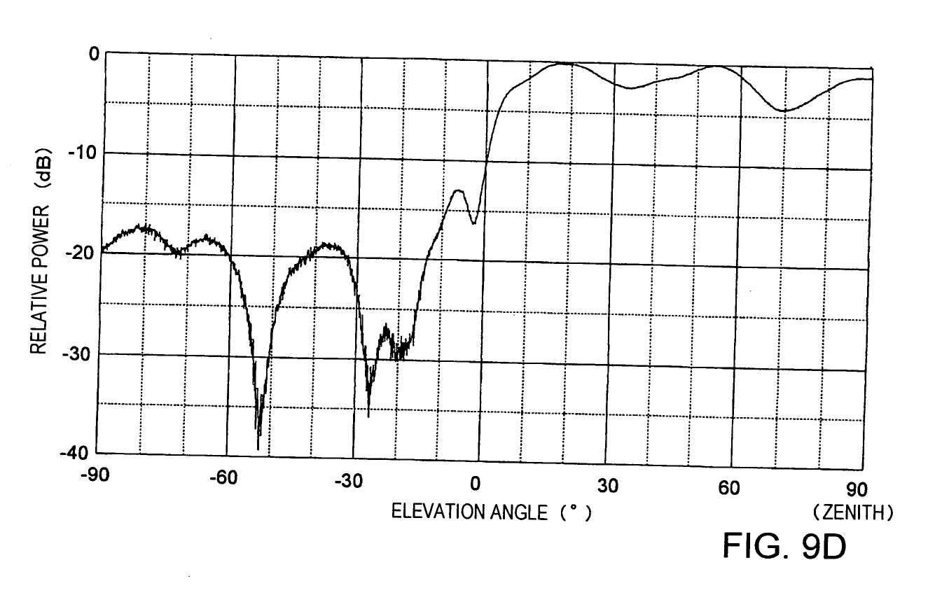

When the antenna device was installed such that the reference plane of the antenna device was parallel with the horizontal plane, and the directive characteristic was measured for each orientation within the horizontal plane with each of the elevation angle at 10° and 30°, results shown in FIG. 8 were found. As shown in FIG. 8, it is understood that this antenna device is substantially uniform directive in the horizontal in-plane direction. Also, when a vertical-plane amplitude pattern in the (+)-direction of the x-axis was measured in the aforementioned xyz coordinate system, results shown in FIG. 9A were found. Likewise, results shown in FIGS. 9B, 9C and 9D were found as vertical-plane amplitude patterns in each of the (−)-direction of the y-axis, (−)-direction of the x-axis direction, and (+)-direction of the y-axis, respectively. As is apparent from these vertical-plane amplitude patterns, the amplitude is generally equal to or less than −20 dB in a direction below the reference plane, from which it is understood that this antenna has satisfactory vertical-plane sharp cut-off characteristics. After all, the fabricated antenna device was found to be sufficiently bearable to actual operations as an antenna device for a DGPS base station.

While an illustrative exemplary embodiment of the present invention has been described above, the present invention can be modified in various manners.

In the antenna device of a further exemplary embodiment of the present invention, four dipole antennas can be arranged to have directivities to directions different from one another by 90° on the reference plane in each element array, and a plurality of such element arrays can be held by a mast member in alignment. In a still further exemplary embodiment, a second feeding circuit for each element array includes: a connector for connection with a transmission line extended to the element array; a first 90° hybrid coupler having an input terminal connected to the connector; a second 90° hybrid coupler having an input terminal connected to a 0° output terminal of the first 90° hybrid coupler; and a third 90° hybrid coupler connected to a 90° output terminal of the first 90° hybrid coupler through a delay line portion for giving a phase delay of 90°. In this event, four dipole antennas of the element array are connected to output terminals (0° output terminal and 90° output terminal) of the second and third 90° hybrid couplers, respectively.

In a yet further exemplary embodiment of the present invention, each element array is preferably powered at a predetermined level ratio defined for each element array in order to accomplish desired directive characteristics. Further, the antenna device of a further exemplary embodiment of the present invention may comprise a plurality of parasitic element arrays each including four dipole antennas. Such parasitic element arrays are held by the mast member such that they are arranged in a direction perpendicular to the reference plane.

Also, in the antenna device of a further exemplary embodiment of the present invention, the number of element arrays can be, for example, an odd number. Specifically, the number of element arrays is, for example, 11, or 7, 9, 13 or the like. With an odd number of element arrays, assuming that an element array at the center of the element arrays is designated as a central element array, and the central element array and element arrays adjacent thereto are arranged at intervals of a, while the remaining element arrays except for the central element array are arranged at intervals of 2a, it is preferable that element arrays on one side of the central element array is fed with a phase difference of −90°, while element arrays on the other side are fed with a phase difference of +90° with reference to the central element array (i.e., fed with a phase difference of 0°). When parasitic element arrays are arranged in such a configuration, such parasitic element arrays are preferably positioned at the midpoint of the interval 2a between the element arrays. Further, a parasitic element array may be disposed at a position spaced apart by a, outward from each of element arrays positioned at the ends of the set of the element arrays. When parasitic element arrays are provided, these parasitic element arrays are preferably aligned with respect to the element arrays fed by first feeding means.

In an exemplary embodiment of the present invention, each dipole antenna preferably has its antenna conductor which extends in a direction inclined with respect to the reference plane. The angle of inclination is, for example, from 20° to 30°.

According to the present invention, since highly symmetric second feeding means can be employed for feeding each dipole antenna of an element array from a single feeding point of each element array, the axial symmetry of the antenna pattern can also be improved, by way of example. According to the present invention, since coaxial cables can be employed as a transmission path, interference between the transmission paths can also be prevented, by way of example.

While exemplary embodiments of the present invention have been described using specific terms, such description is for illustrative purposes only, and it is to be understood that changes and variations may be made without departing from the spirit or scope of the following claims.

What is claimed is:

1. An antenna device comprising:
a plurality of element arrays;
a mast member which holds said plurality of element arrays such that said element arrays are arranged in a direction perpendicular to a reference plane; and
a first feeding circuit which feeds said element arrays,
wherein said each element array comprises: a predetermined number of dipole antennas; and a second feeding circuit which feeds said predetermined number of dipole antennas such that said predetermined number of dipole antennas can transmit and/or receive predetermined circularly polarized wave components alone,
for each of said element arrays, said first feeding circuit and said second feeding circuit of said element array are connected through an independent transmission path, and
said each element array is fed with a predetermined phase difference.

2. The antenna device according to claim 1, wherein:
in said each element array, said predetermined number of dipole antennas are arranged to have directivities in directions different from one another by a predetermined angle within said reference plane, and
said plurality of element arrays are held by said mast member in alignment.

3. The antenna device according to claim 1, wherein said predetermined number of dipole antennas are four dipole antennas.

4. The antenna device according to claim 3, wherein:
in said each element array, said four dipole antennas are arranged to have directivities in directions different from one another by 90° within said reference plane, and
said plurality of element arrays are held by said mast member in alignment.

5. The antenna device according to claim 4, wherein said second feeding circuit comprises: a connector connected to said transmission path; a first 90° hybrid coupler having an input terminal connected to said connector; a second 90° hybrid coupler having an input terminal connected to a 0° output terminal of said first 90° hybrid coupler; and a third 90° hybrid coupler connected to a 90° output terminal of said first 90° hybrid coupler through a delay line portion for giving a phase delay of 90°, and wherein the dipole antennas are connected to output terminals of said second and third 90° hybrid couplers, respectively.

6. The antenna device according to claim 1, wherein said each element array is fed at a predetermined level ratio defined for each element array.

7. The antenna device according to claim 3, wherein said each element array is fed at a predetermined level ratio defined for each element array.

8. The antenna device according to claim 3, comprising an odd number of said element arrays, wherein among said odd number of said element arrays, the remaining element arrays except for a central element array are arranged at equal intervals to each other, and with reference to said central element array, element arrays on one side of said central element array are fed with a phase difference of +90°, and element arrays on the other side are fed with a phase difference of −90°.

9. The antenna device according to claim 3, further comprising a plurality of parasitic element arrays each including four dipole antennas, wherein said parasitic element arrays are held by said mast member so as to be arranged in a direction perpendicular to said reference plane.

10. The antenna device according to claim 1, wherein said each dipole antenna includes an antenna conductor which extends in a direction inclined with respect to said reference plane.

11. The antenna device according to claim 3, wherein said each dipole antenna includes an antenna conductor which extends in a direction inclined with respect to said reference plane.

12. An antenna device comprising:
a plurality of element arrays;
a mast member for holding said plurality of element arrays such that said element arrays are arranged in a direction perpendicular to a reference plane; and
first feeding means for feeding said element arrays,
wherein said each element array comprises: a predetermined number of dipole antennas; and second feeding means for feeding said predetermined number of dipole antennas such that said predetermined number of dipole antennas can transmit and/or receive predetermined circularly polarized wave components alone,
for each of said element arrays, said first feeding means and said second feeding means of said element array are connected through an independent transmission path, and
said each element array is fed with a predetermined phase difference.

13. The antenna device according to claim 12, wherein said predetermined number is four.
